(19) United States
(12) Patent Application Publication
(10) Pub. No.: US 2007/0059641 A1
(43) Pub. Date: Mar. 15, 2007

(54) Optical recording medium and polymethine complex for use in the recording layer of the optical recording medium

(75) Inventors: Ming-Chia Li, Hsinchu Hsien (TW); Chien-Liang Huang, Hsinchu Hsien (TW); Wen-Yih Liao, Hsinchu Hsien (TW); Tzuan-Ren Jeng, Hsinchu Hsien (TW); Ching-Yu Hsieh, Hsinchu Hsien (TW); An-Tse Lee, Hsinchu Hsien (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/514,846

(22) Filed: Sep. 5, 2006

(30) Foreign Application Priority Data
Sep. 9, 2005 (TW) 094131060

(51) Int. Cl. G11B 7/24

(52) U.S. Cl. 430/270.19; 430/270.18; 428/64.8; 369/283

(57) ABSTRACT

The present invention relates to a polymethine complex and an optical recording medium using said polymethine complex. Through using the polymethine complex formed by combining a polymethine cation with a heat-inhibiting anion as the optical recording material in the optical recording medium, not only the heat inference caused by thermal decomposition of the dyes during high speed optical recording can be reduced or avoided, but also absorption coefficient, sensitivity and recording speed in the region of ultraviolet and visible light of 300˜800 nm wavelength can be increased. The optical recording medium according to the present invention can achieve high-speed writing and reading with Pi errors less than 280 in case that the reflective layer of the optical recording medium has a minimal thickness of 50 nm. Furthermore, the optical recording medium according to the present invention may comprise the polymethine complex as the sole optical recording material such that the optical recording medium can be recovered for reuse, which will reduce the cost of manufacture. The optical recording medium according to the present invention also permits that both red laser recording and blue laser recording are performed synchronically.

### FIELD OF THE INVENTION

The present invention relates to an optical recording material and an optical recording medium using the same, more particularly, to a polymethine complex for use in the recording layer of the optical recording medium and an optical recording medium using the polymethine complex.

### BACKGROUND OF THE INVENTION

With rapid advancement of information communication, a variety of information needs to be stored in a compact storage medium having higher storage density, smaller size, higher recording speed and lower cost. The conventional magnetic storage media do not meet the demand of the current development of information technology; therefore, development of novel optical recording materials becomes an intensive topic. Furthermore, with increased storage density, the storage capacity of the optical recording media of WORM (Write-Once-Read-Many) type has been greatly increased from early CD-R to presently most prevalent DVDR, and further to blue laser optical recording media (HD-DVD-R and BD-R). Therefore, preparation of functional dyes through combining organic synthesis and photochemistry and application of the functional dyes in various fields (for example, nonlinear optical element, recording and reproducing of optical disc data, medical treatment and biological technologies) become the topics to confront in the art.

In 1981, Law et al. disclosed a method of manufacturing optical discs for use with a near infrared laser pick-up head, wherein a cyanine dye (3,3′-diethyl-12-acetyl-thiatetracyanine perchlorate) was used as the optical recording material (K. Y Law, P. S. Vincett, and G. E. Johnson, Appl. Phys. Lett., 39, 718). The method comprises mixing the cyanine dye with polyvinyl acetate (PVAC) and then spin-coating the resulting mixture on a substrate to form an optical disk. With successful application of the cyanine dyes in optical recording materials, a variety of dyes having different structures have been developed and used in optical storage media for various purposes. For example, Taiwan Patent Publication No. 593561, Japanese Patent No. 072,254,167, 09,193,545, 09,194,545, 09,226,250, 09,274,732, 10,044,066, 11,310,728 and the like, disclosed methods of manufacturing optical recording media by using organic dyes as optical recording materials and spin coating these organic dyes on substrates.

Although the methods disclosed by the above patents can simplify the process, reduce the cost and increase optical recording speed, the following problems may occur due to increased optical recording speed:
1. High-speed optical recording may elevate thermal interference in the recording layer of the optical recording medium and result in higher jitter;
2. High-speed optical recording may cause damage of land pre-pits for data addressing, which will lead to more PI error.

### SUMMARY OF THE INVENTION

In view of the disadvantages of the conventional techniques as stated above, the main object of the present invention is to provide a polymethine complex that can avoid or reduce thermal interference in the recording layer during high-speed recording.

Another object of the present invention is to provide an optical recording medium using the polymethine complex as the optical recording material, which has high absorption coefficient, high sensitivity and high recording speed in the region of ultraviolet and visible light of 300˜800 nm wavelength.

A further object of the present invention is to provide an optical recording medium using the polymethine complex as the sole optical recording material such that the optical recording medium can be recovered for reuse so as to reduce the cost of manufacture.

Another further object of the present invention is to provide an optical recording medium using the polymethine complex as the optical recording material, which permits red laser optical storage and blue laser optical storage are performed synchronically.

Another further object of the present invention is to provide an optical recording medium using the polymethine complex as the optical recording material, which permits high-speed writing and reading with PI errors less than 280 in case that the reflective layer of the optical recording medium has a minimal thickness of 50 nm.

To achieve the above objects, the present invention provides a polymethine complex as the optical recording material, comprising at least
(a) a cation of formula (A) 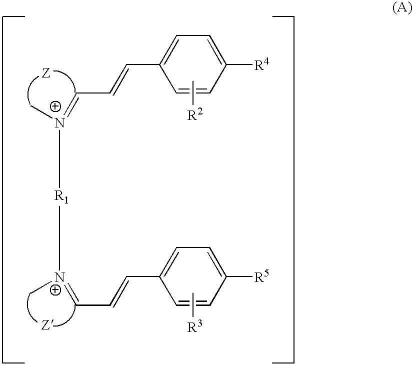
   wherein

Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sulfo, carboxy, alkoxycarbonyl and cyano;

R¹ represents:
(1) a C₁₋₁₈ alkylene group, unsubstituted or substituted with a halogen atom, a C₁₋₁₈ alkoxy or oxo group,
(2) an ether group consisting of a C₁₋₁₈ alkylene group interrupted by one or more oxygen atoms, and
(3) -p-C₁₋₆ alkyl-benzyl-;

R², R³, R⁴ and R⁵ independently represent a hydrogen atom, a halogen atom, C₁₋₁₈ alkyl, C₁₋₁₈ alkoxyl, carboxyl, C₁₋₁₈ alkoxycarbonyl, C₁₋₁₈ alkylaminoalkylenecarboxyl, adamantyl, amino, mono- or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, nitrogen- or oxygen-containing heterocyclic group;
(b) an anion of formula (B):

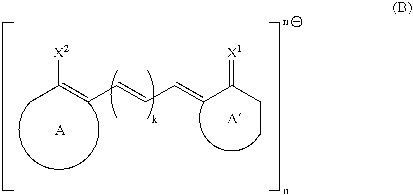

wherein

X¹ and X² each represent an oxygen atom;

ring A and ring A′ each represent an unsubstituted or substituted organic cyclic structure;

k is an integer selected from 0 to 3; and

n is an integer selected from 0 to 2 such that the polymethine complex, as a whole, has neutral electric charge.

The present invention also provides a polymethine complex for use in the recoding medium comprising at least:
(a) a cation of formula (C): 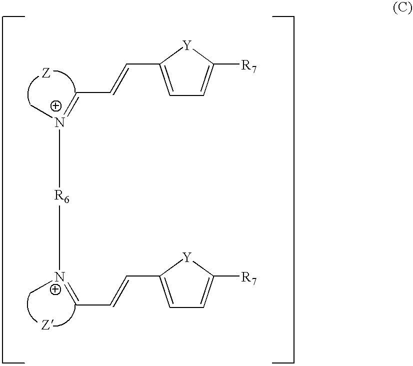
   wherein

Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sulfo, carboxy, alkoxycarbonyl and cyano;

Y represents O or S;

R⁶ represents:
(1) a C₁₋₁₈ alkylene group, unsubstituted or substituted with a halogen atom, a C₁₋₁₈ alkoxy or oxo group,
(2) an ether group consisting of a C₁₋₁₈ alkylene group interrupted by one or more oxygen atoms, and
(3) -p-C₁₋₆ alkyl-benzyl-;

R⁷ represents a hydrogen atom, a halogen atom, C₁₋₁₈ alkyl, C₁₋₁₈ alkoxyl, carboxyl, C₁₋₁₈ alkoxycarbonyl, C₁₋₁₈ alkylaminoalkylenecarboxyl, adamantly, amino, mono-or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, nitrogen- or oxygen-containing heterocyclic group;
(b) an anion of formula (B):

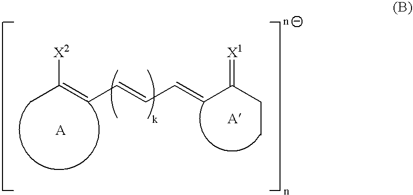

wherein

X¹ and X² each represent an oxygen atom;

ring A and ring A′ each represent an unsubstituted or substituted organic cyclic structure;

k is an integer selected from 0 to 3; and

n is an integer selected from 0 to 2 such that the polymethine complex, as a whole, has neutral electric charge.

The polymethine complex according to the present invention, through combining a polymethine cation and a heat-inhibiting anion, causes less thermal interference during high speed optical recording because thermal decomposition of the heat-inhibiting anion during optical recording is endothermic, which can offset the heat produced by thermal decomposition of polymethine cation (exothermic) during optical recording. Furthermore, due to the presence of polymethine cation, the absorption coefficient, sensitivity and recording speed in the region of ultraviolet and visible light of 300-800 nm wavelength are increased. Therefore, the polymethine complex according to the present invention is suitable for use as the optical recording material in optical recording media, especially high-speed optical recording media.

The present invention further provides an optical recording medium comprising at least:

a first substrate;

a recording layer provided on the first substrate, comprising at least one polymethine complex as defined above as the optical recording material;

a reflective layer provided on the recording layer; and

a second substrate laminated on the reflective layer.

By using the polymethine complex as the optical recording material, the optical recording medium according to the present invention can obtain a jitter of about 8% and Pi errors less than 280 during high-speed optical recording in case that the reflective layer in the optical recording medium has a minimal thickness of 50 nm.

Furthermore, the optical recording medium wherein the recording layer comprises the polymethine complex as the sole component can be recovered for reuse, which will reduce the cost of manufacture. In addition, the optical recording medium according to the present invention permits that red laser optical storage and blue laser optical storage are performed synchronically.

### BRIEF DESCRIPTION OF THE DRAWINGS

FIG. 1 shows the general formula of one representative polymethine complex according to the present invention.

FIG. 2 is a schematic diagram showing the procedures for producing the polymethine complex according to the present invention.

FIG. 3 is a graph showing the result of simultaneous differential scanning calorimeter-thermogravimetric analysis (DSC-TGA) for the polymethine complex according to the present invention;

FIG. 4 is a graph showing the result of simultaneous DSC-TGA for a conventional bisphenylethenyl compound;

FIG. 5 is a graph showing the result of simultaneous DSC-TGA for a conventional oxonol dye.

### DETAILED DESCRIPTION OF THE INVENTION

The polymethine complex and the optical recording medium using said polymethine complex according to the present invention are described with reference to the following specific embodiments and examples. A person skilled in the art can readily understand other advantages and effects of the present invention from the contents disclosed in the specification. The present invention can also be performed or applied by other different embodiments. The present invention can be modified and altered in various ways without departing from the spirit of the present invention.

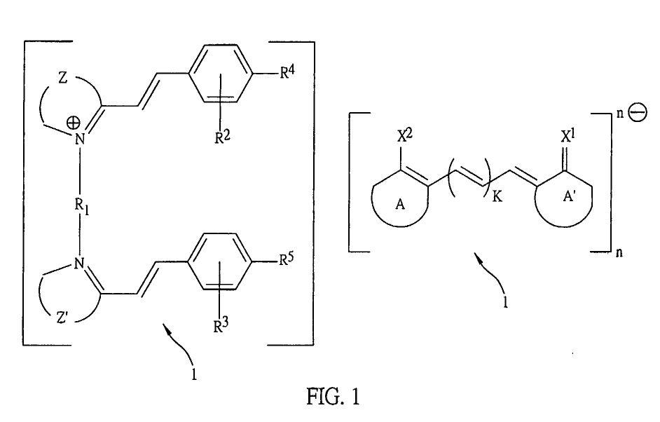

According to the present invention, one polymethine complex suitable for use in the recording layer of the optical recording medium, as shown in FIG. 1, comprises at least
(a) a cation of formula (A) 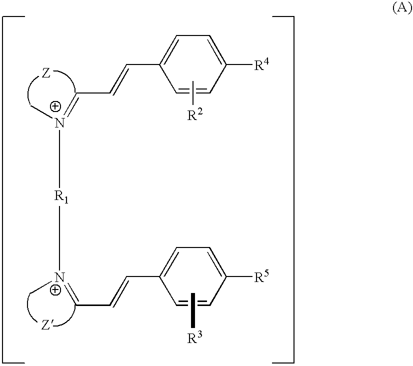
   wherein

Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sultfo, carboxy, alkoxycarbonyl and cyano;

R¹ represents:
(1) a C₁₋₁₈ alkylene group, unsubstituted or substituted with a halogen atom, a C₁₋₁₈ alkoxy or oxo group,
(2) an ether group consisting of a C₁₋₁₈ alkylene group interrupted by one or more oxygen atoms, and
(3) -p-C₁₋₁₆alkyl-benzyl-;

R², R³, R⁴ and R⁵ independently represent a hydrogen atom, a halogen atom, C₁₋₁₈ alkyl, C₁₋₁₈ alkoxyl, carboxyl, C₁₋₁₈ alkoxycarbonyl, C₁₋₁₈ alkylaminoalkylenecarboxyl, adamantyl, amino, mono- or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, nitrogen- or oxygen-containing heterocyclic group;
(b) an anion of formula (B):

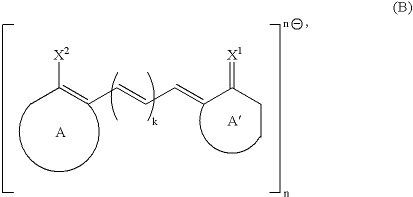

wherein

X¹ and X² each represent an oxygen atom;

ring A and ring A′ each represent an unsubstituted or substituted organic cyclic structure;

k is an integer selected from 0 to 3; and

n is an integer selected from 0 to 2 such that the polymethine complex, as a whole, has neutral electric charge.

The anion of formula (B) in the above polymethine complex preferably has a structure of formula (B-1), (B-2) or (B-3): 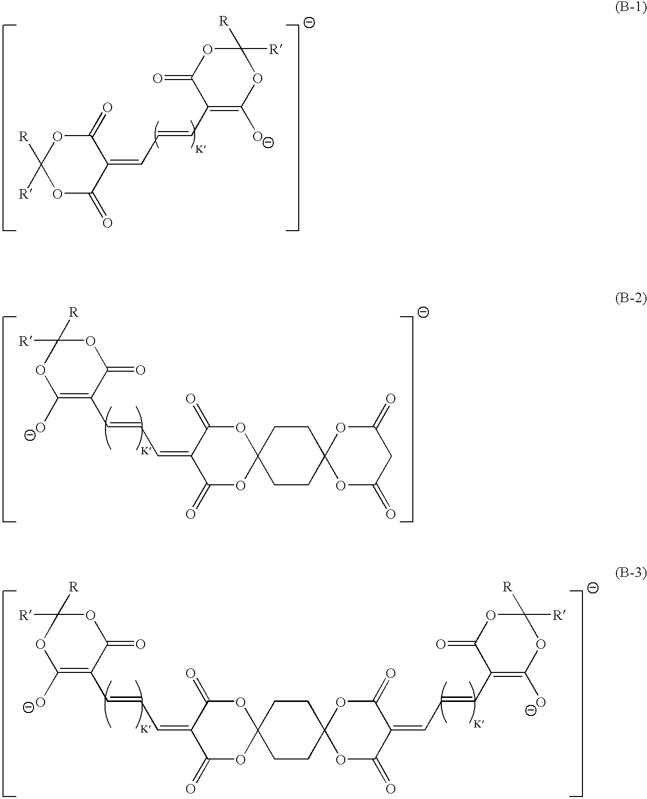
wherein

R and R′ independently represent C₁₋₁₈ alkyl, aryl, mono- or poly-carbocyclic group or ferrocenyl; or

R and R′, with the carbon atom they are attached to, are bonded together to form a saturated monocarbocyclic group;

k′ is an integer of 1 or 2.

Preferably, R and R′ in the formula (B-1), (B-2) or (B-3) independently represent C₁₋₆ alkyl, C₆₋₁₀ aryl, C₅₋₁₂ saturated mono- or poly-carbocyclic group or ferrocenyl; alternatively, R and R′, with the carbon atom they are attached to, are bonded together to form a saturated C₅₋₈ monocarbocyclic group. More preferably, R and R′ in the formula (B-1), (B-2) or (B-3) represent methyl, phenyl, bicyclo[2.2.1]heptane, admantyl or ferrocenyl; alternatively, R and R′, with the carbon atom they are attached to, are bonded together to form a cyclohexyl group.

According to the present invention, another polymethine complex suitable for use in the recording layer of the recording medium comprises at least:
(a) a cation of formula (C) 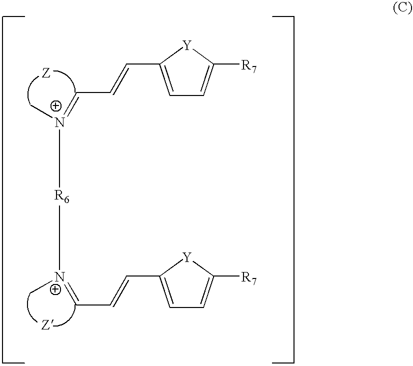
   wherein

Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sulfo, carboxy, alkoxycarbonyl and cyano; Y represents O or S;

R⁶ represents:
(1) a C₁₋₁₈ alkylene group, unsubstituted or substituted with a halogen atom, a C₁₋₁₈ alkoxy or oxo group,
(2) an ether group consisting of a C₁₋₁₈ alkylene group interrupted by one or more oxygen atoms, and
(3) -p-C₁₋₆ alkyl-benzyl-;

R⁷ represents a hydrogen atom, a halogen atom, C₁₋₁₈ alkyl, C₁₋₁₈ alkoxyl, carboxyl, C₁₋₁₈ alkoxycarbonyl, C₁₋₁₈ alkylaminoalkylenecarboxyl, adamantly, amino, mono- or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, nitrogen- or oxygen-containing heterocyclic group;
(b) an anion of formula (B): 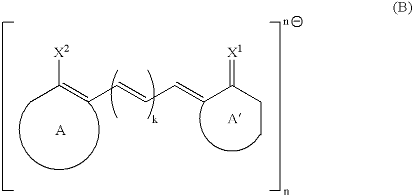
   wherein

X¹ and X² each represent an oxygen atom;

ring A and ring A′ each represent an unsubstituted or substituted organic cyclic structure;

k is an integer selected from 0 to 3; and

n is an integer selected from 0 to 2 such that the polymethine complex, as a whole, has neutral electric charge.

The anion of formula (B) in the above polymethine complex preferably has a structure of formula (B-1): 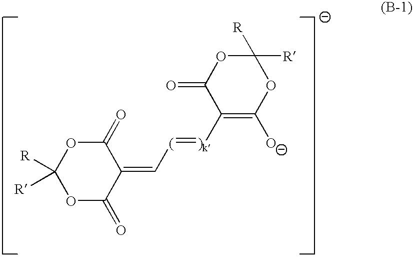
wherein

R and R′ independently represent C₁₋₁₈ alkyl, aryl, mono- or poly-carbocyclic group or ferrocenyl, preferably represent C₁₋₆ alkyl; and

k′ is an integer of 1 or 2.

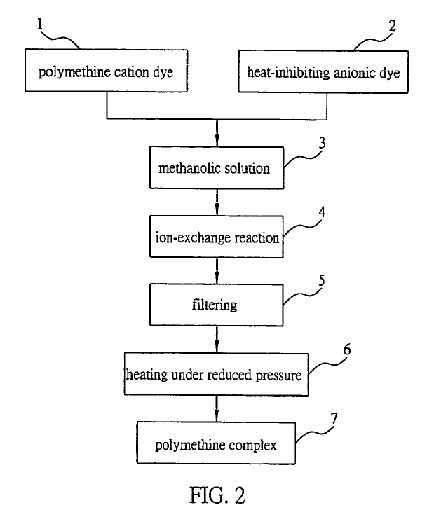

As shown in FIG. 2, the polymethine complex according to the present invention is prepared by dissolving an iodide-containing polymethine cationic dye 1 and a quaternary ammonium complex of a heat-inhibiting anion 2 in methanol to form a methanolic solution 3, subjecting the methanolic solution to an ion-exchange reaction 4; collecting the precipitated solid by filtration 5 after the ion-exchange reaction 4 has been completed, and drying the solid by heating under reduced pressure 6 to give a polymethine complex 7 as solid. The polymethine complex 7 has the maximum absorption in the region of ultraviolet and visible light (300˜800 nm), and is suitable for use as the optical recording material in a high-density optical recording medium.

The preferable polymethine complexes according to the present invention are listed below, but are not limited thereto.

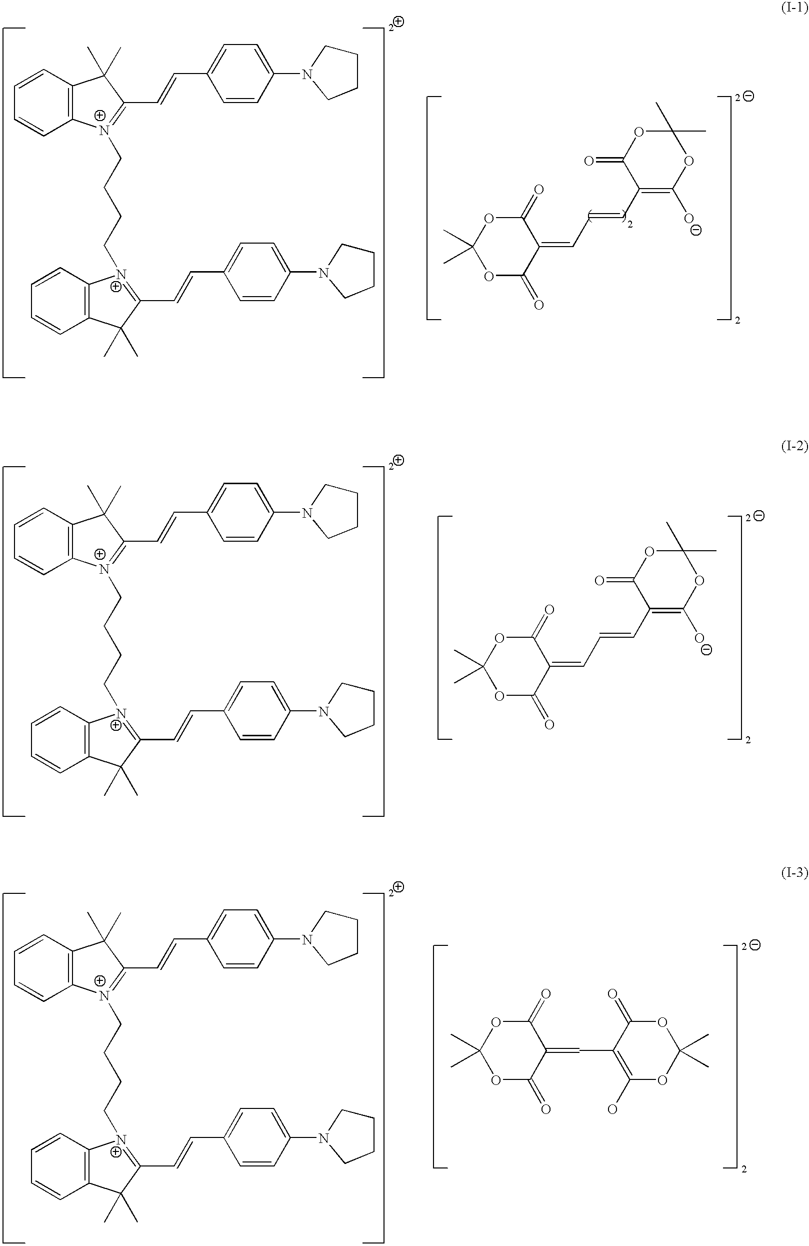

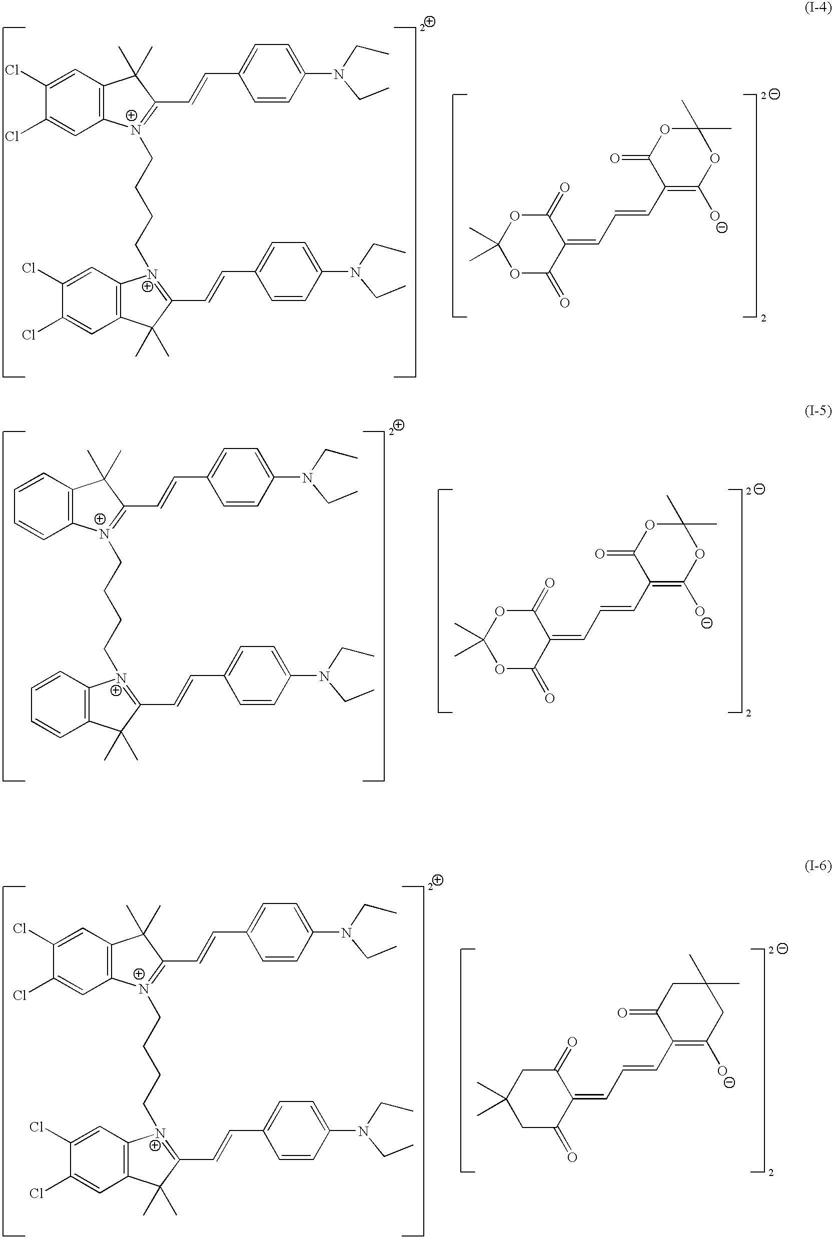

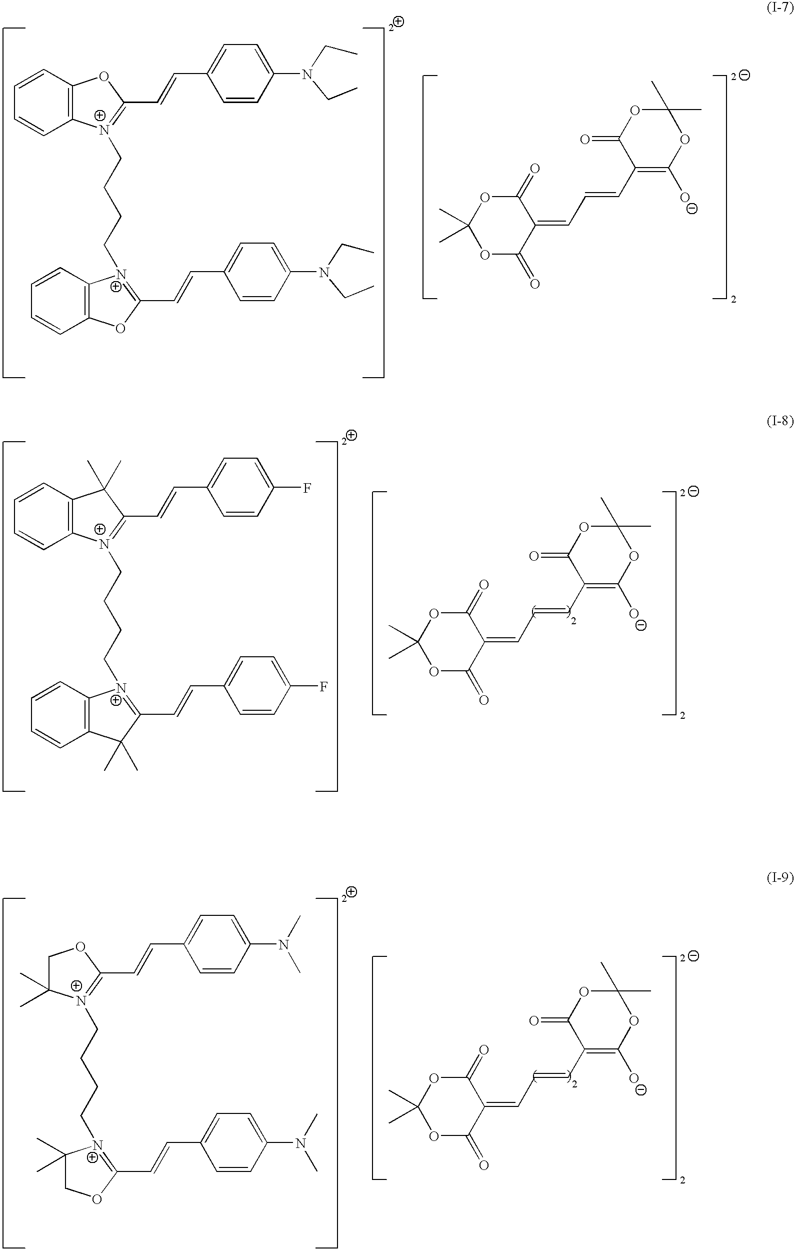

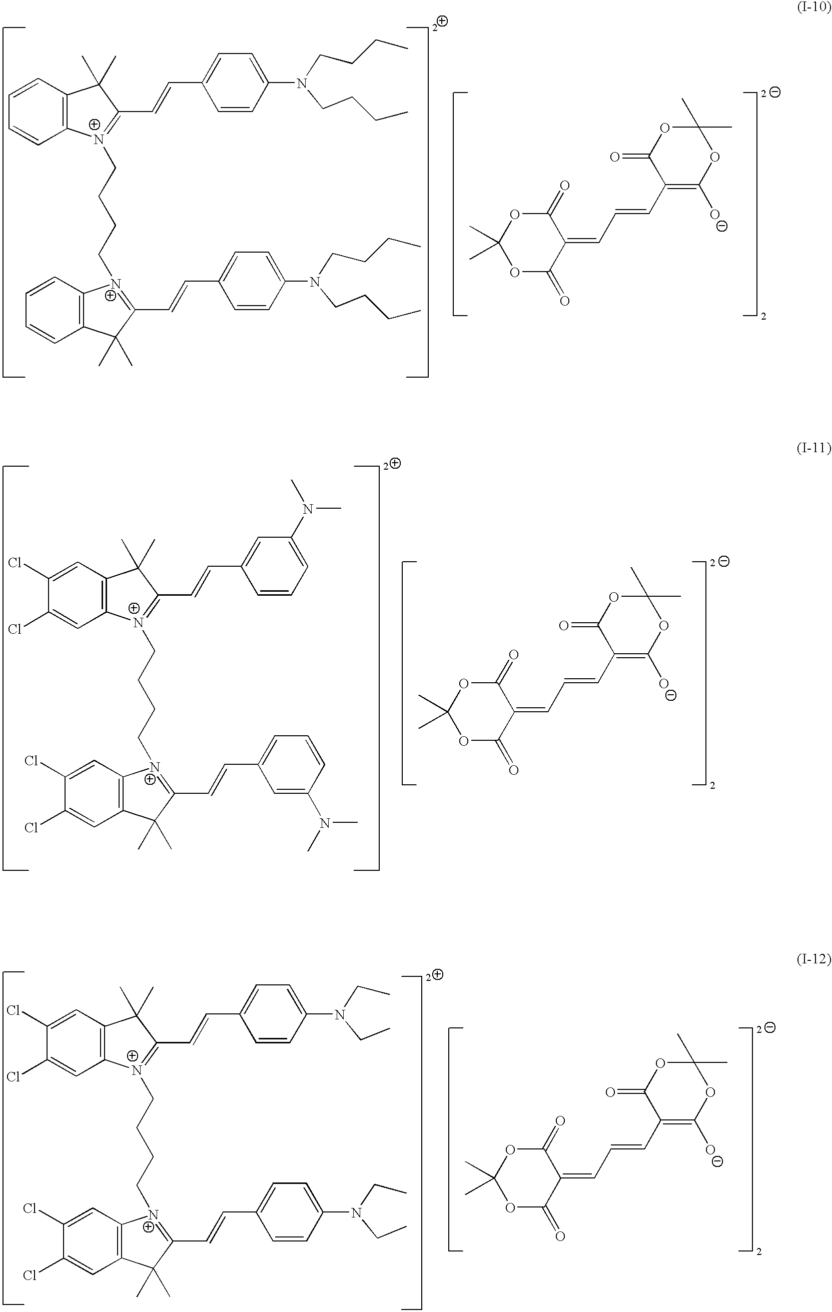

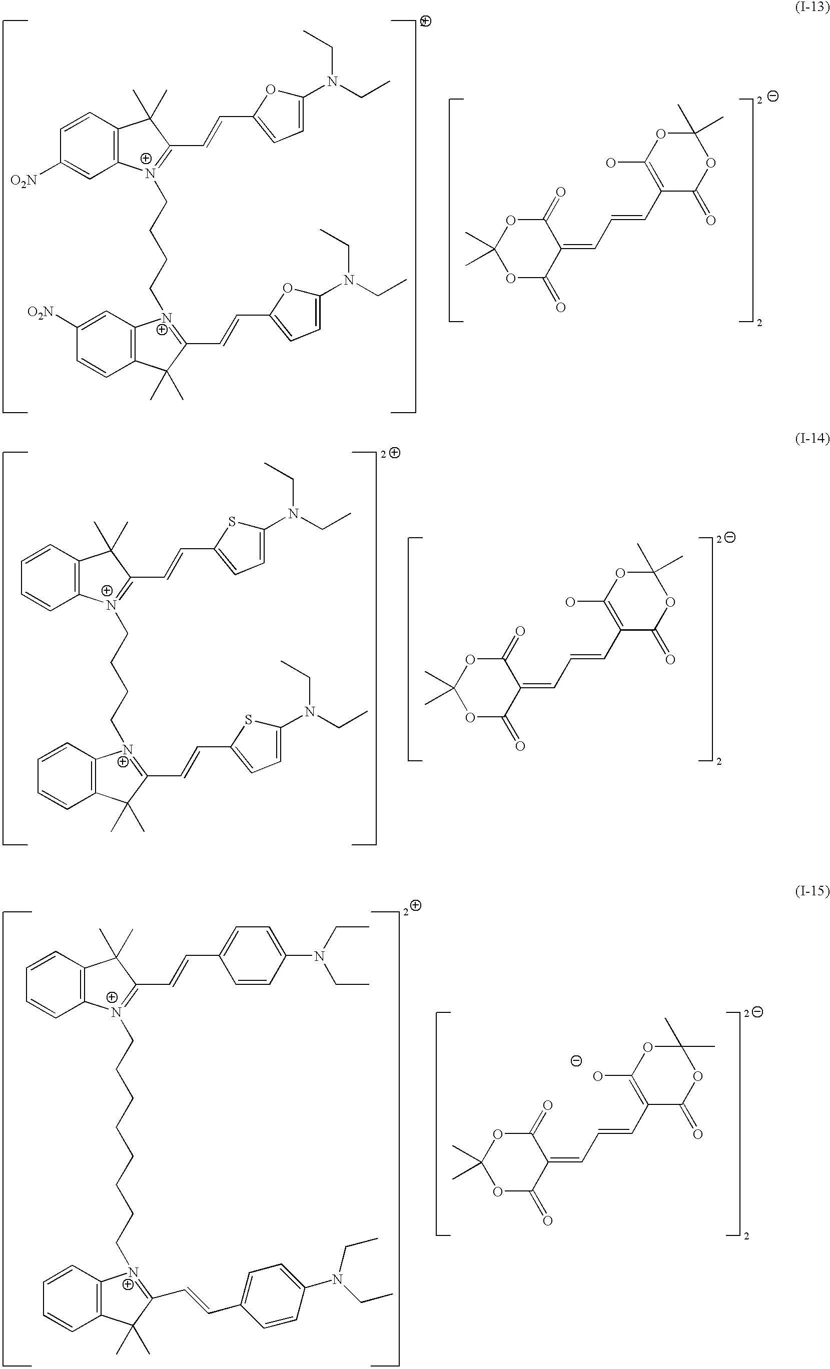

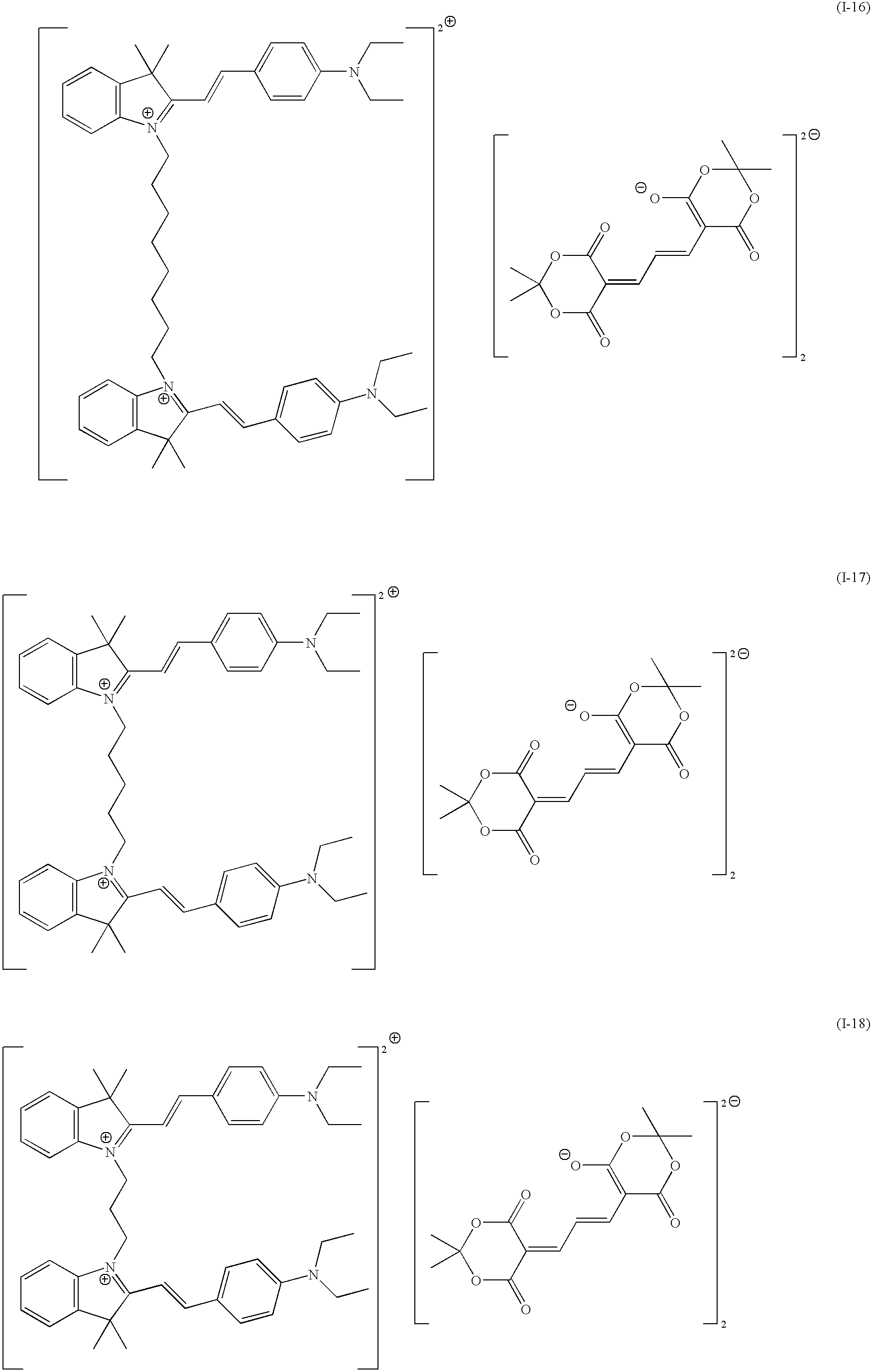

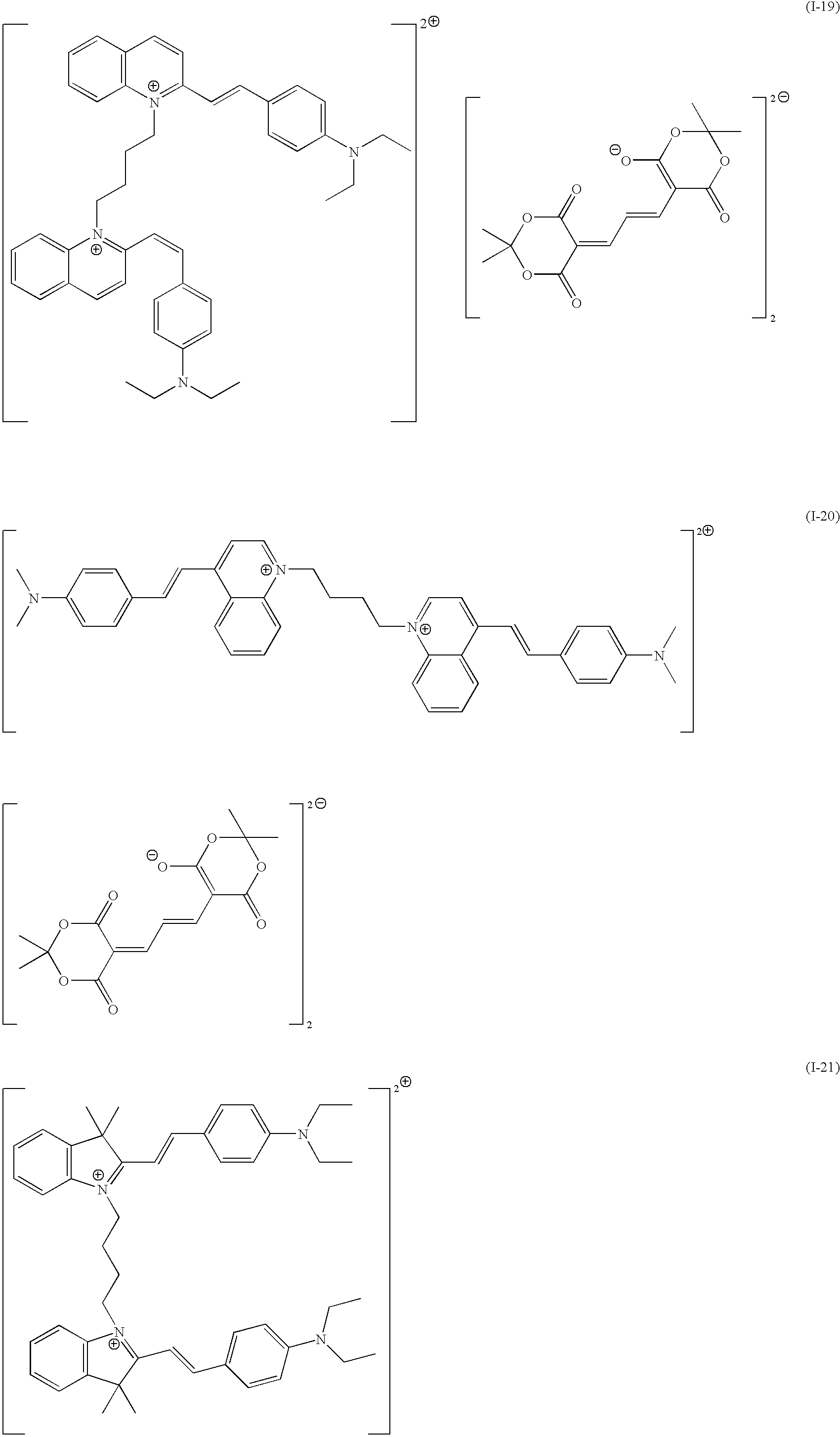

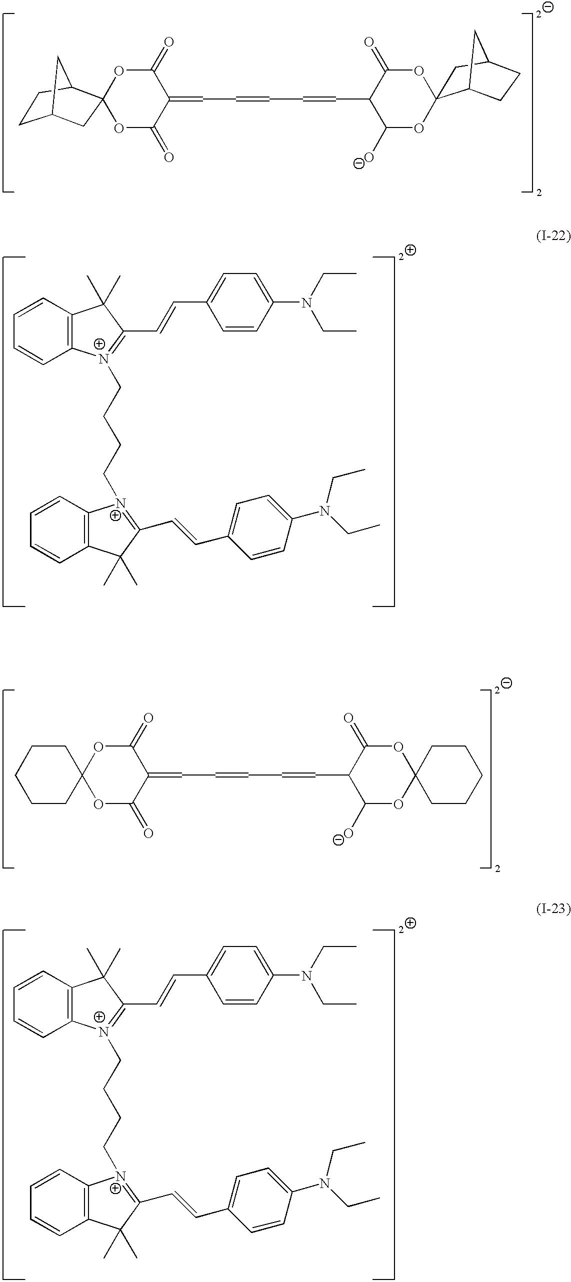

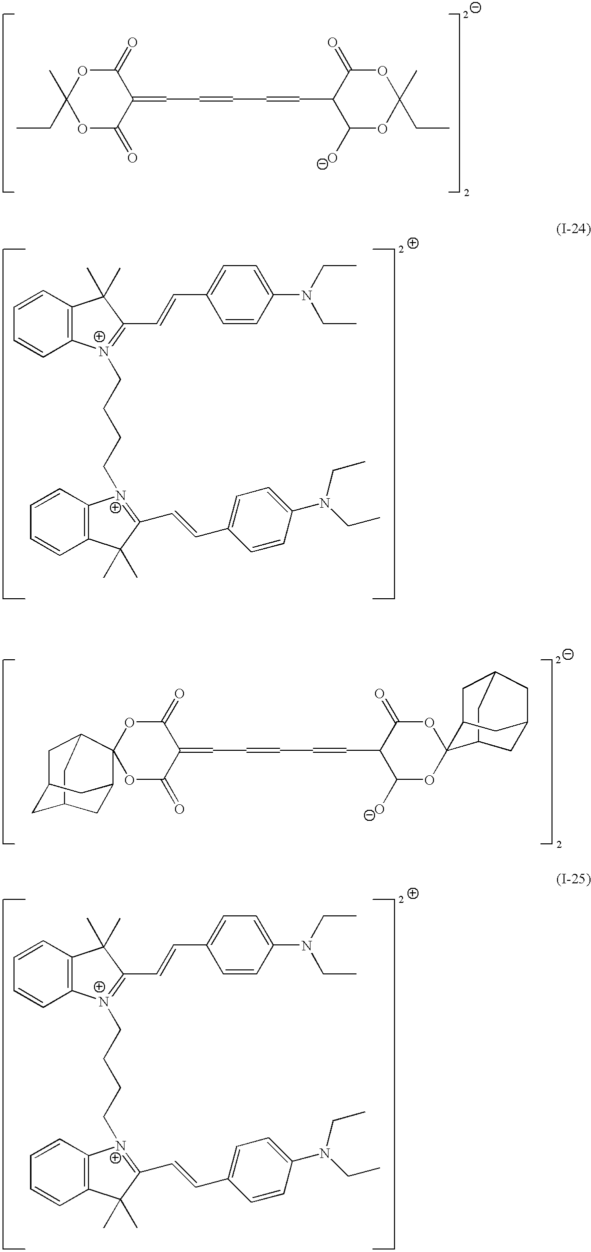

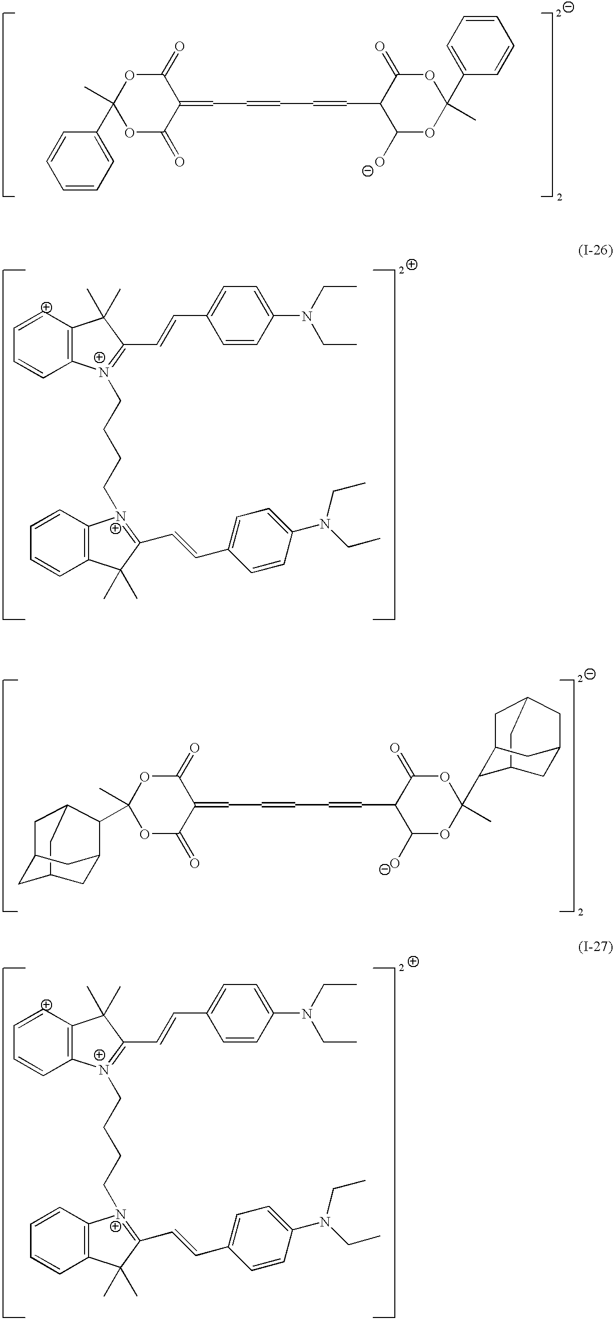

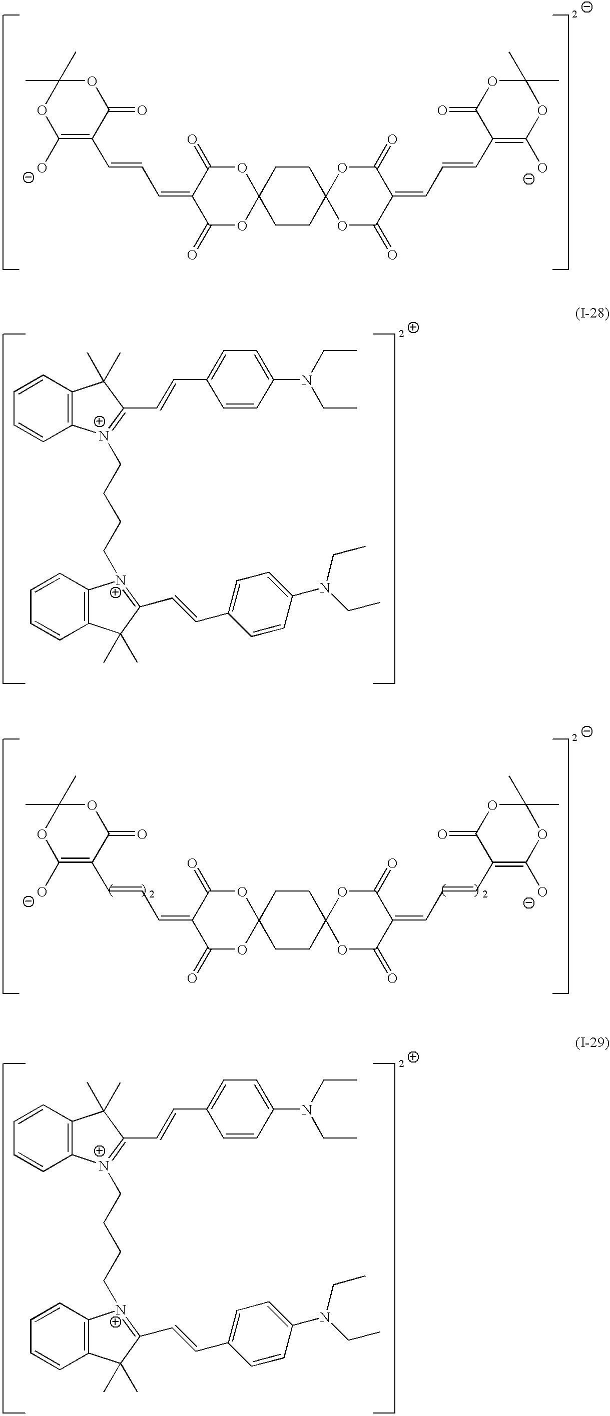

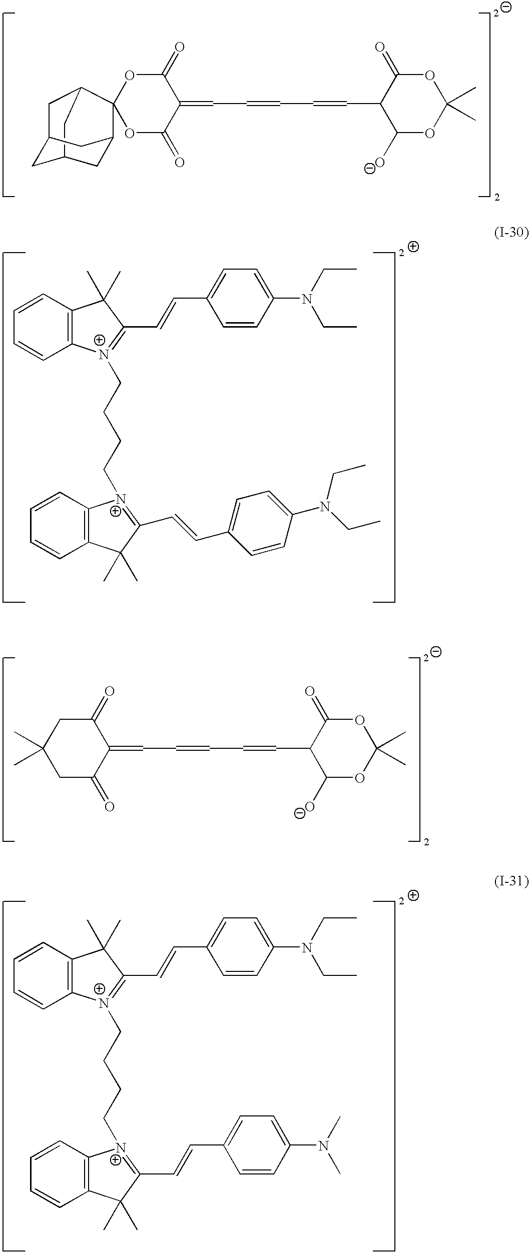

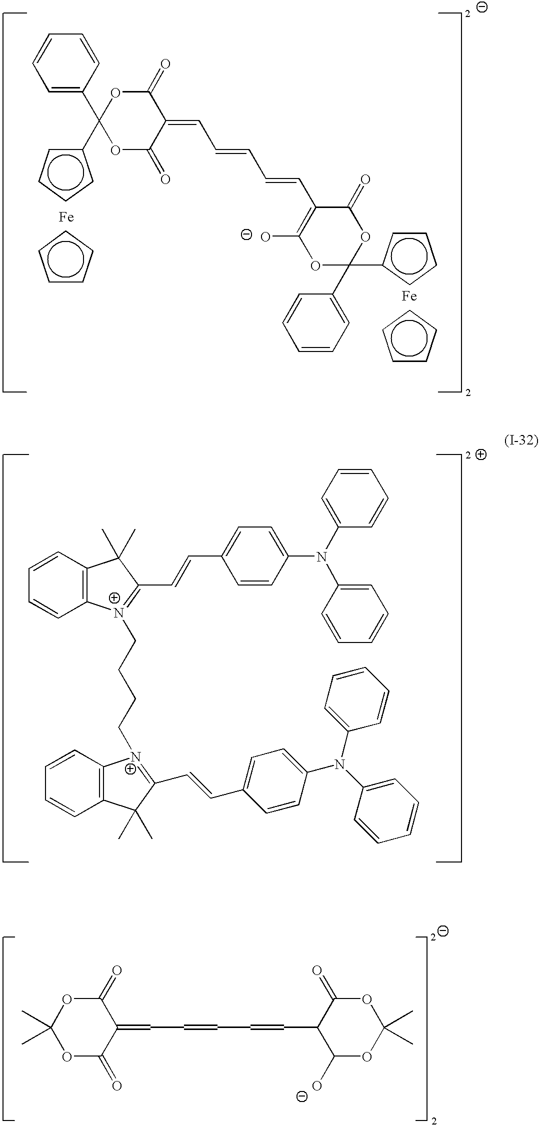

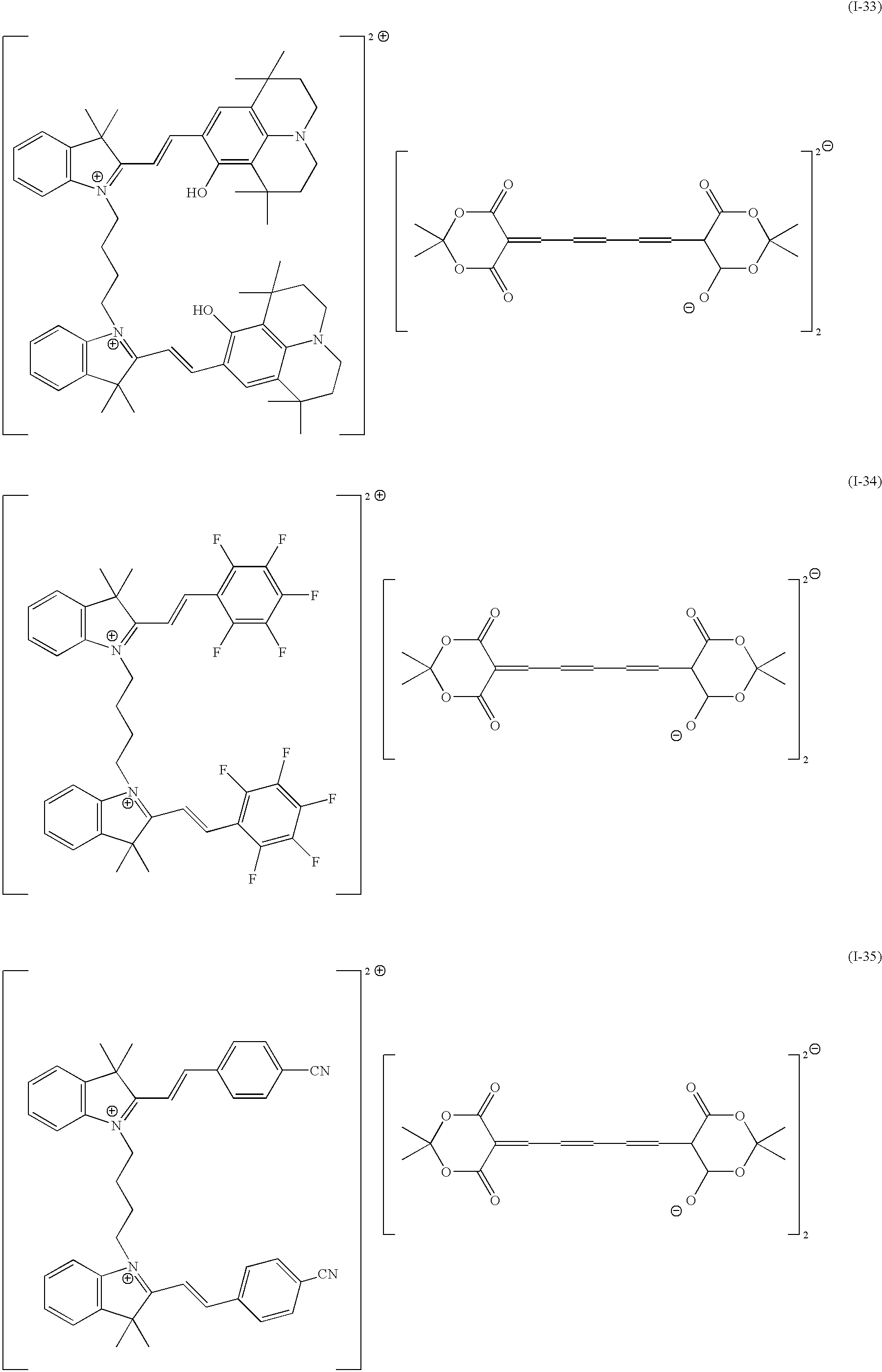

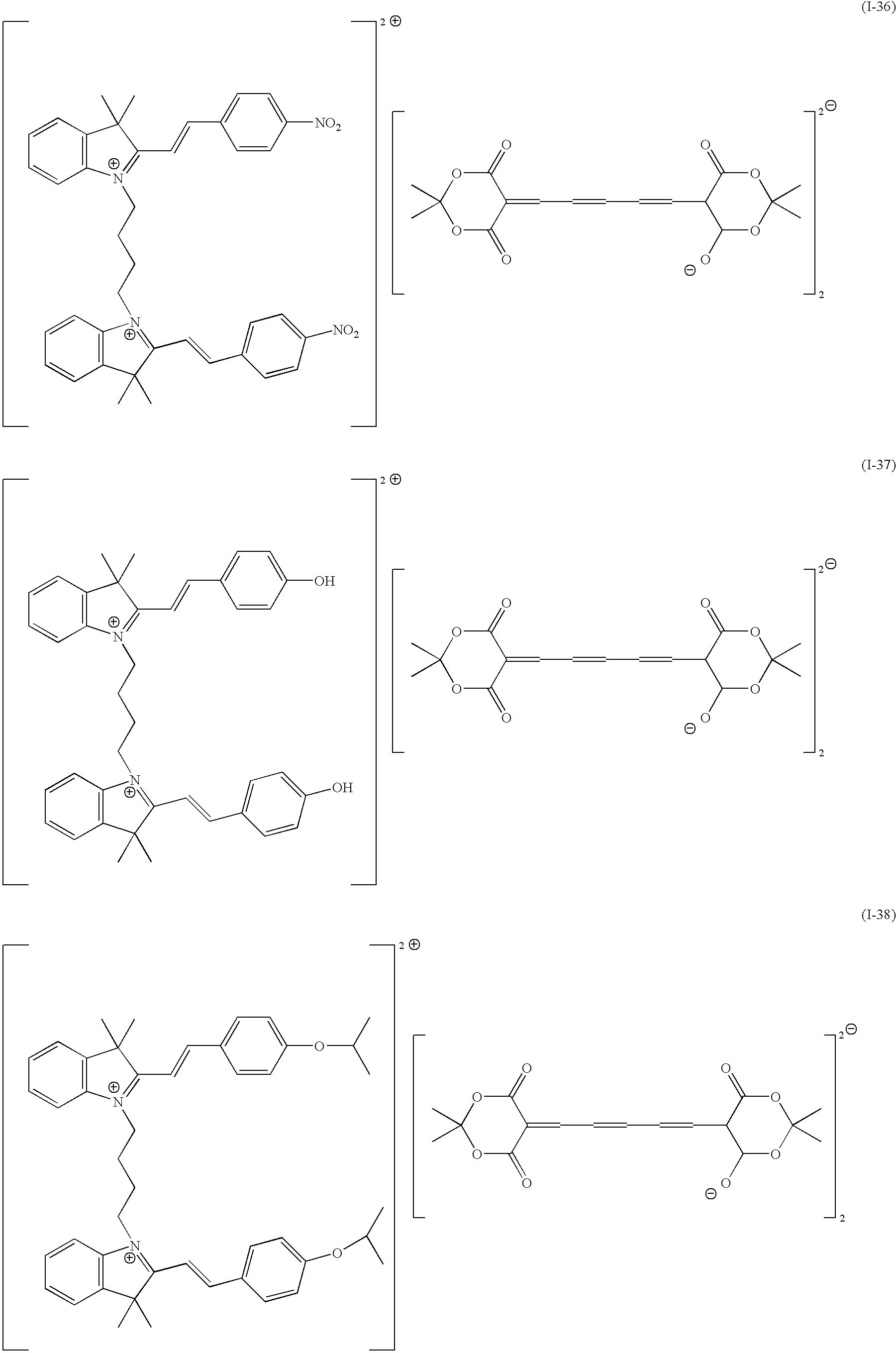

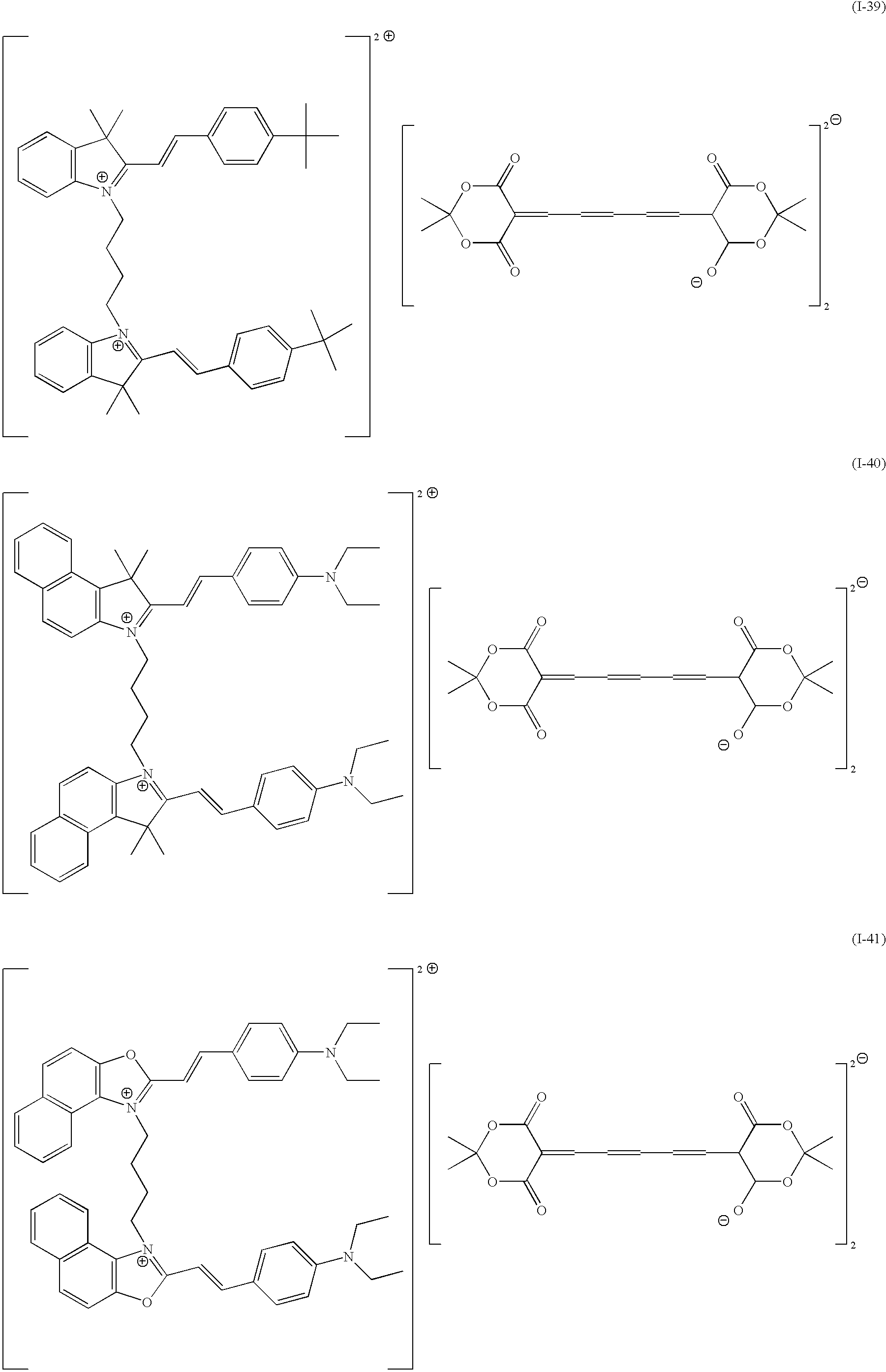

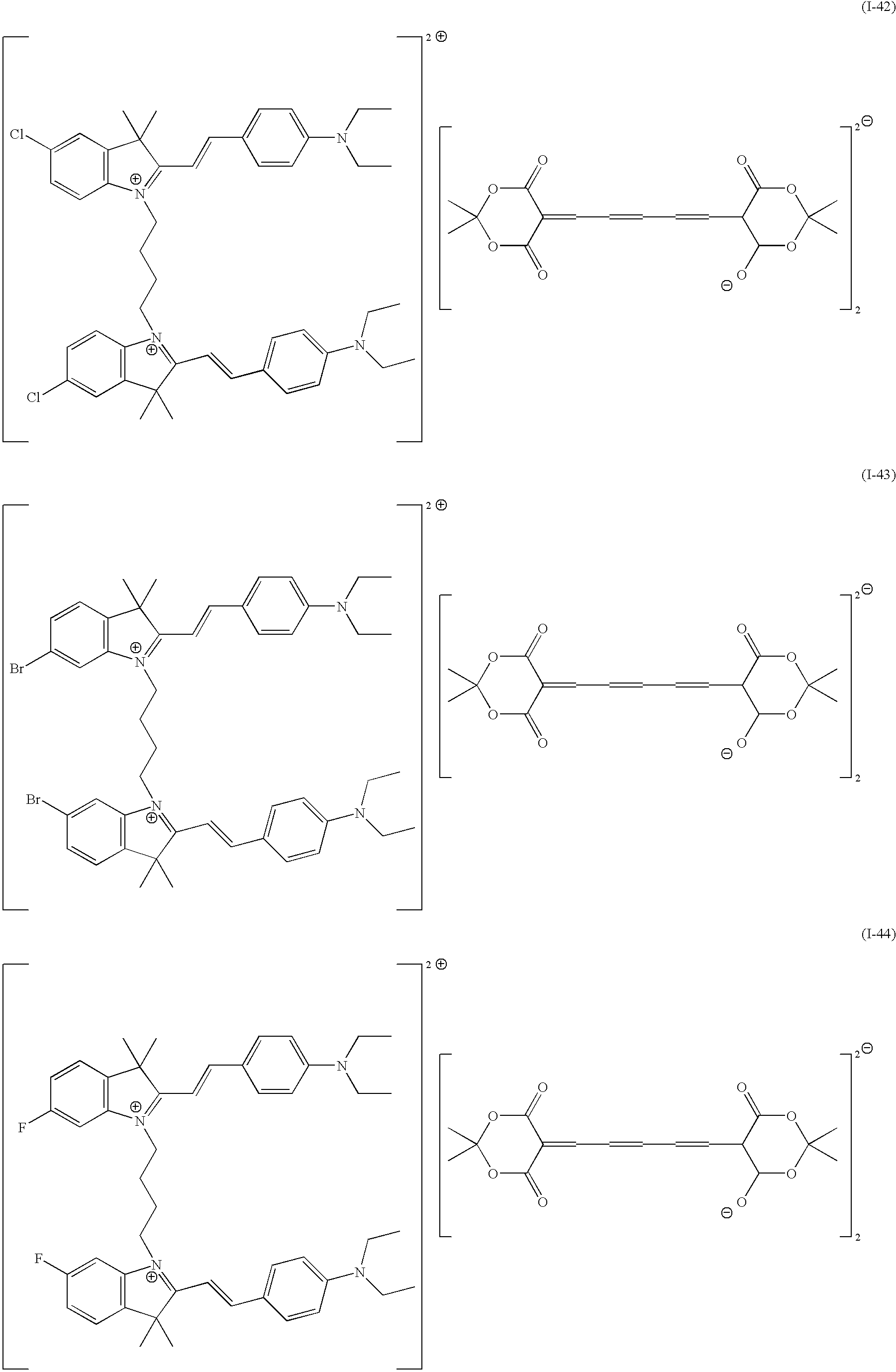

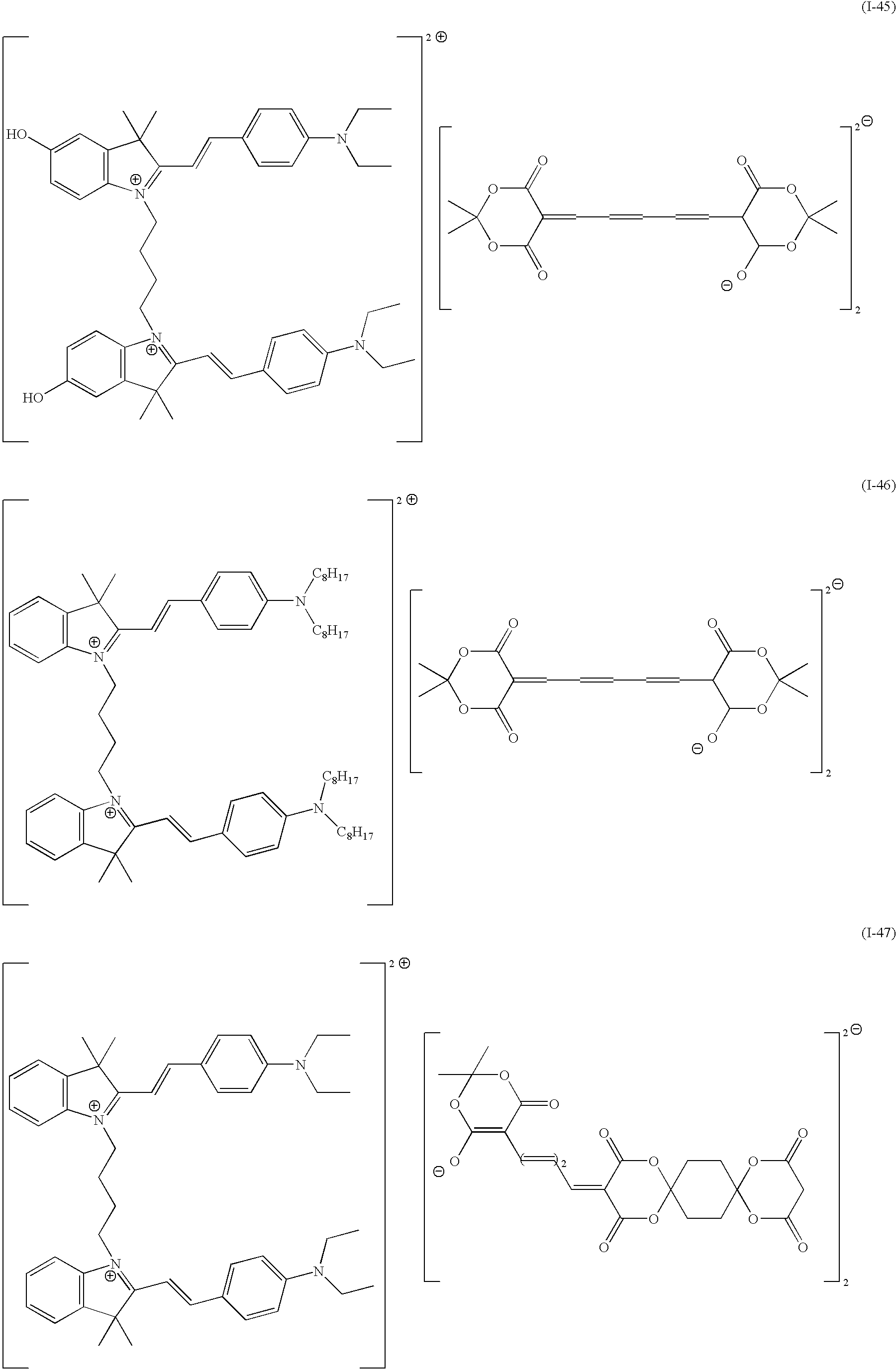

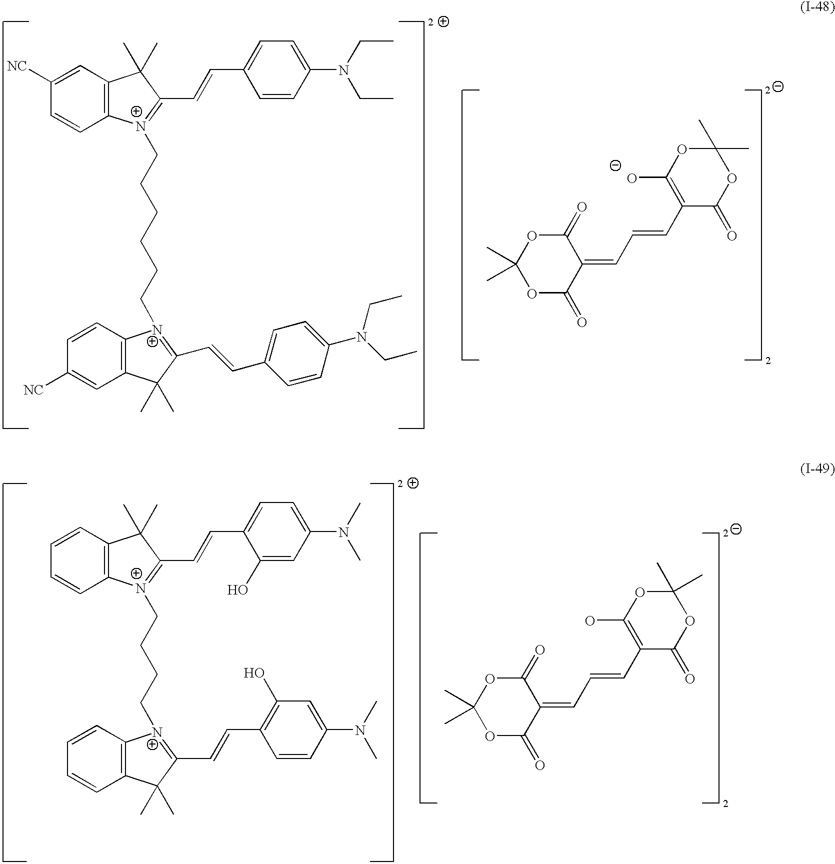

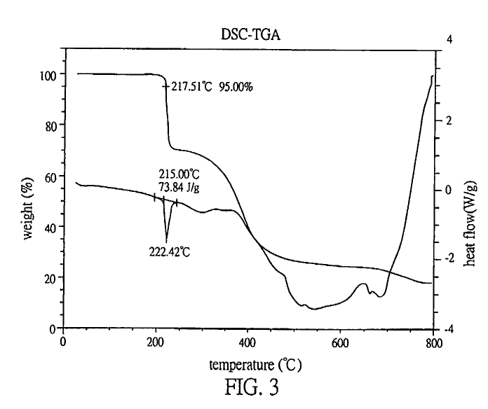

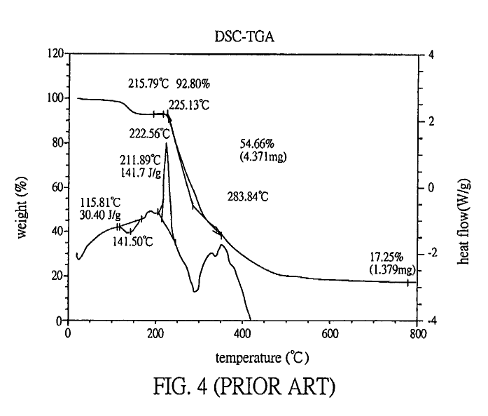

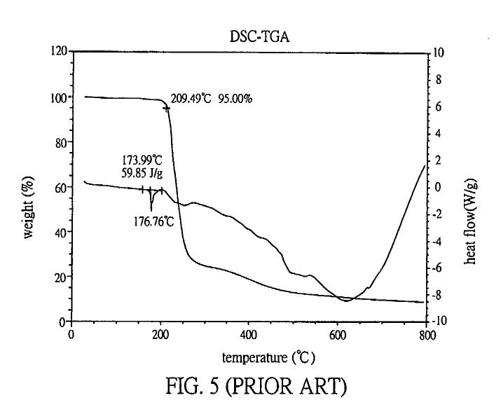

FIGS. 3 to 5 show the results of simultaneous differential scanning calotimeter-thermogravimetric analysis (DSC-TGA) for the polymethine complex according to the present invention, a conventional bisphenylethenyl compound (having a cation identical to the cation of the compound (P-1) as shown in Example 1 and an anion of SbF6) and a conventional oxonol dye (O-1) having a structure as shown in Example 1, respectively. As shown in FIGS. 3 to 5, both thermal decomposition of the polymethine complex according to the present invention and thermal decomposition of the oxonol dye belong to endothermic reactions, while thermal decomposition of the conventional bisphenylethenyl compound belongs to an exothermic reaction. It suggests that, through combining a polymethine cation and a heat-inhibiting anion, heat generation can be reduced in the process of thermal decomposition of the dyes, and hence the problems caused by remarkable thermal interference during high speed optical recording, which were usually encountered by the conventional optical recording media, can be solved. In addition, the optical sensitivity of the dye can be increased due to presence of polymethine cations.

Besides as the optical recording materials in optical recording media, the polymethine complexes according to the present invention are also useful as the photoresist in the integrated circuit and are applicable in the fields of fiber dying, copying and printing.

The present invention further provides an optical recording medium comprising at least:

a first substrate;

a recording layer provided on the first substrate, composed of an optical recording material comprising at least polymethine complex as defined above;

a reflective layer provided on the recording layer; and

a second substrate laminated on the reflective layer.

In more details, the optical recording medium according to the present invention is prepared by dissolving the polymethine complex in an organic solvent such as an alcohol, a ketone, an ester, an ether, a halide or an amide etc. and then coating the resulting solution on a substrate by a method selected from spin coating, roll coating, dip coating, ink jet printing or the like. The coated substrate is then subjected to a spreading process and a baking process to form a recording layer on the first substrate. The recording layer usually has a thickness of 30 to 200 nm. Then, silver is plated on the recording layer to form a reflective layer. The reflective layer usually has a thickness of 5 to 300 nm, preferably 10 to 250 nm, more preferably 50 to 200 nm. Then, a second substrate made of, for example, polycarbonate is laminated on the reflective layer by a method selected from spin coating, screen printing or hot melt glue coating to give an optical recording medium.

The writing and reading operations of the optical recording medium obtained above can be evaluated by using a PULSTEC DDU-1000 tester. The writing operation is implemented under a condition including a laser wavelength of 405 nm or 658 nm, a numerical aperture (NA) of 0.65 or 0.6 and a power of 7 to 14 mW. The reading operation is implemented under a condition including a laser wavelength of 405 nm or 658 nm, a numerical aperture (NA) of 0.65 or 0.6 and a power of 0.5 to 1.5 mW.

R14H (%), PI error and jitter (%) of the optical recording medium can be evaluated by using a Expert-107D tester.

As shown in the following Examples, the optical recording medium according to the present invention shows high carrier noise ratio (CNR), and less PI errors and lower jitter (%), when compared with conventional optical recording media.

### EXAMPLES

### Example 1

### Preparation of a Polymethine Complex

0.01 mole of a bisphenylethenyl compound (P-1) (providing polymethine cation) of the following formula 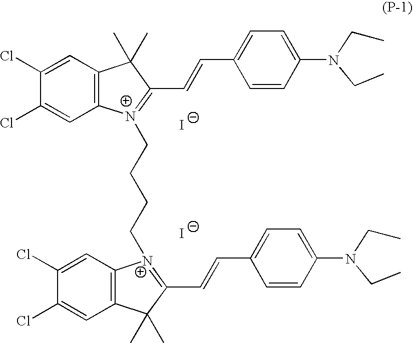
and 0.02 mole of an oxanol dye (O-1) (providing a heat-inhibiting anion) of the following formula 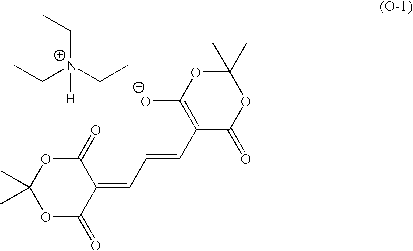
were dissolved in 20 ml of methanol. The resulting solution was heated to reflux temperature to perform an ion-exchange reaction for 3 hours. The precipitated solid was collected by filtration after the ion-exchange reaction had been completed, and dried by heating under reduced pressure to give a polymethine complex (I-4) as a brown solid crystal with a yield of 70%.

The structure of the polymethine complex (I-4) is as follows:

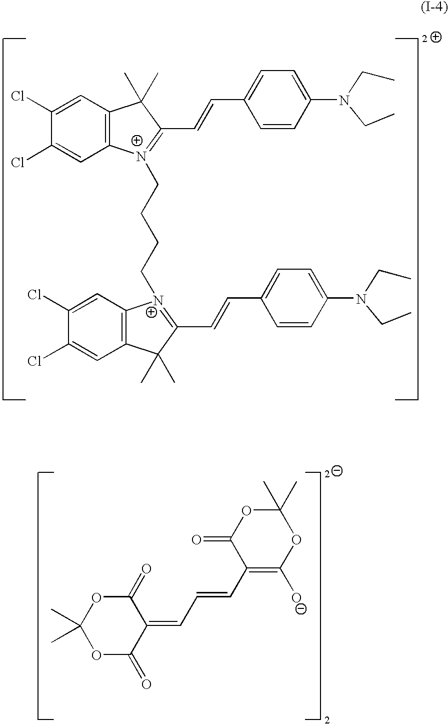

### Example 2

### Manufacture of an Optical Recording Medium

1.5 g of the polymethine complex of formula (I-4) was dissolved in 2,2,3,3-tetrafluoropropanol to form 100 ml of a solution. The solution was applied on a first substrate by spin coating. A DVD-R substrate made of transparent polycarbonate having grooves of 0.74 μm wide and having a thickness of 0.6 mm, and a HD-DVD-R substrate made of transparent polycarbonate having grooves of 0.4 μm wide and having a thickness of 0.6 mm, were used as the first substrates, respectively. The coated first substrate was then subjected to a spreading process and a baking process to form a polymethine complex layer (recording layer) on the first substrate. Silver was plated on the recording layer to form a reflective layer of 50 nm thick, and then a second substrate made of polycarbonate with a thickness of 0.6 mm was laminated on the reflective layer by spin coating to give an optical recording medium or a high-density optical recording medium with a thickness of 120 mm.

### Example 3

### Tests for the Optical Recording Medium

The writing and reading operations of the optical recording medium obtained above were evaluated by using a PULSTEC DDU-1000 tester. The writing operation was implemented under a condition including a laser wavelength of 405 nm or 658 nm, a numerical aperture (NA) of 0.65 or 0.6 and a power of 10 mW. The reading operation was implemented under a condition including a laser wavelength of 405 nm or 658 nm, a numerical aperture (NA) of 0.65 or 0.6 and a power of 0.5 to 1.5 mW.

The 3T CNR (Carrier/Noise Ratio) was 51 dB in case of DVD-R recorded by a red laser at 658 nm; and 45 dB in case of HD-DVD-R recorded by a blue laser at 405 nm.

Furthermore, an optical recording medium (A) using a polymethine complex (I-24) as the optical recording material and a conventional optical recording medium (P) using a bisphenylethenyl compound (P-2) as the optical recording material (the radius of disk >40 mm) were recorded by using a commercial 8× speed DVDR burner (NEC 3500A), respectively. After recording, R14H (%), Pi errors and jitter (%) of the optical recording medium (A) and the conventional optical recording medium (P) were tested respectively by using a Expert-107D tester and the results were listed in the Tables 1 and 2, respectively.

TABLE 1
The Performance of the optical recording medium (A) according to the present invention

| | Thickness | | | | | | | | |
|---|---|---|---|---|---|---|---|---|---|
| | 25 mm | 30 mm | 35 mm | 40 mm | 45 mm | 50 mm | 55 mm | 60 mm | 65 mm |
| R14H (%) | 63 | 63.2 | 63.1 | 64 | 64.5 | 64.3 | 64.3 | 64.8 | 65.2 |
| PI errors | 91 | 77 | 48 | 48 | 119 | 29 | 201 | 78 | 179 |
| Jitter (%) | 7.47 | 7.62 | 8.92 | 8.71 | 9.22 | 9.16 | 9.25 | 9.47 | 9.88 |

TABLE 2
The Performance of the conventional optical recording medium (P) according to
the present invention

| | Thickness | | | | | | | | |
|---|---|---|---|---|---|---|---|---|---|
| | 25 mm | 30 mm | 35 mm | 40 mm | 45 mm | 50 mm | 55 mm | 60 mm | 65 mm |
| R14H (%) | 53.2 | 56.5 | 58.6 | 58.6 | 59.8 | 60.2 | 60.5 | 60.6 | 60.3 |
| PI errors | 557 | 947 | 1502 | 1660 | 1662 | 1662 | 1662 | 1662 | 1662 |
| Jitter (%) | 10.45 | 11.33 | 11.82 | 13.28 | 18.39 | 18.35 | 18.91 | 19.06 | 18.86 |

As shown in Tables 1 and 2, the optical recording medium (A) has higher R14H and lower jitter compared with the conventional optical recording medium (P). The PI errors are less than 280 for the optical recording medium (A), while the PI errors are more than 280 for the optical recording medium (P). These results indicate that through using the polymethine complex according to the present invention as the optical recording material, high jitter (%) and high PI errors due to thermal interference caused by thermal decomposition of the dye(s) in the recording layer, especially during high speed optical recording, can be greatly reduced.

The Examples as stated above are only to illustrate the principle and effects of the present invention but not to limit the present invention in any way. Modifications and alterations can be made by persons skilled in the art without departing from the spirit of the present invention. The scope of the present invention is determined by the CLAIMS as described below.

### EFFECTS OF THE INVENTION

According to the present invention, through using the polymethine complex formed by combining a polymethine cation with a heat-inhibiting anion as the optical recording material in the optical recording medium, not only the heat interference caused by thermal decomposition of the dyes during high speed optical recording can be reduced or avoided, but also absorption coefficient, sensitivity and recording speed in the region of ultraviolet and visible light of 300˜800 nm wavelength can be increased. Therefore, the optical recording medium according to the present invention has high recording sensitivity, high signal/noise ratio, less PI errors and lower jitter; and hence are suitable for use as the optical recording material for high speed optical media. The optical recording medium can achieve high-speed writing and reading with PI errors less than 280 if the reflective layer of the optical recording medium has a minimal thickness of 50 nm.

Furthermore, according the present invention, the recording layer of the optical recording medium may comprise the polymethine complex as the sole optical recording material such that the optical recording medium can be recovered for reuse, which will reduce the cost of manufacture.

Furthermore, the optical recording medium according to the present invention permits that both red laser recording and blue laser recording are performed synchronically.

1. A polymethine complex for use in the recording layer of an optical recording medium, comprising at least
(a) a cation of formula (A) 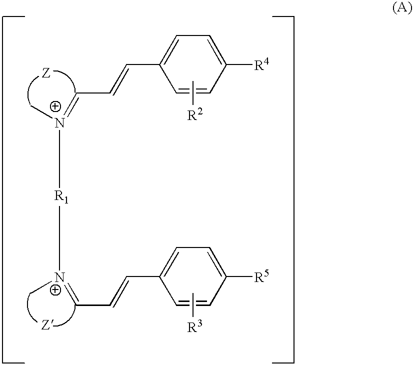
wherein
Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sulfo, carboxy, alkoxycarbonyl and cyano;
R¹ represents:
(1) a C₁₋₁₈ alkylene group, unsubstituted or substituted by a halogen atom, a C₁₋₁₈ alkoxy or oxo group,
(2) an ether group consisting of a C₁₋₁₈ alkylene group interrupted by one or more oxygen atoms, and
(3) -p-C₁₋₆ alkyl-benzyl-;
R², R³, R⁴ and R⁵ independently represent a hydrogen atom, a halogen atom, C₁₋₁₈ alkyl, C₁₋₁₈alkoxyl, carboxyl, C₁₋₁₈ alkoxycarbonyl, C₁₋₁₈ alkylaminoalkylenecarboxyl, adamantyl, amino, mono- or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, or oxygen- or nitrogen-containing heterocyclic group;
(b) an anion of formula (B): 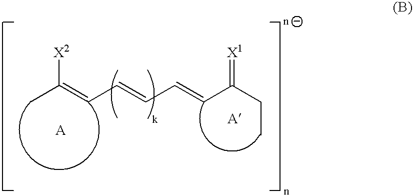
wherein
X¹ and X² each represent an oxygen atom;
ring A and ring A′ each represent an unsubstituted or substituted organic cyclic structure;
k is an integer selected from 0 to 3; and
n is an integer selected from 0 to 2 such that the polymethine complex, as a whole, has neutral electric charge.

2. The polymethine complex of claim 1, wherein the anion has a structure of formula (B-1), (B-2) or (B-3): 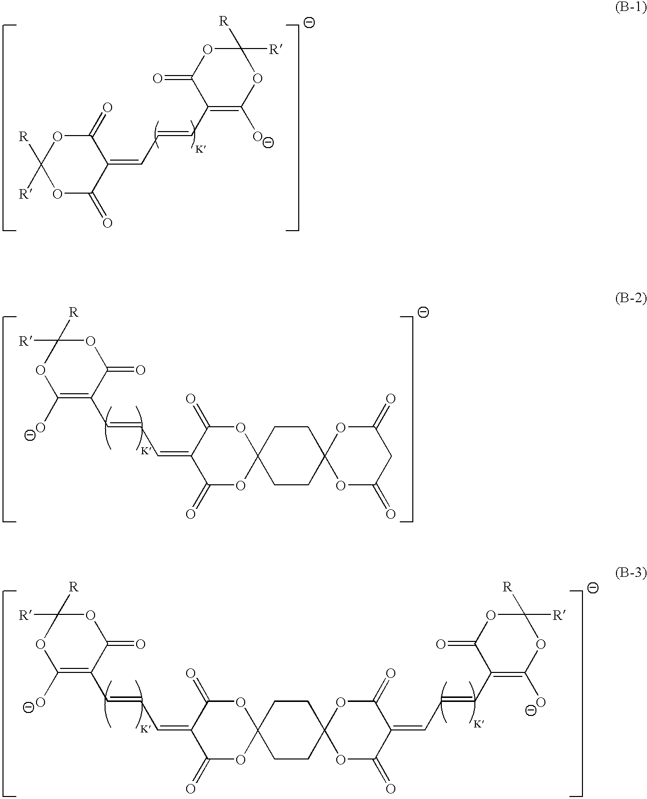
wherein
R and R′ independently represent C₁₋₁₈ alkyl, aryl, mono- or poly-carbocyclic group or ferrocenyl; or
R and R′, with the carbon atom they are attached to, are bonded together to form a saturated monocarbocyclic group;
k′ is an integer of 1 or 2.

3. A polymethine complex for use in the recording layer of an optical recording medium, comprising at least
(a) a cation of formula (C) 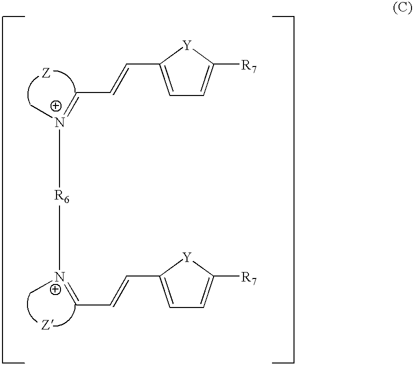
wherein
Z and Z′ represent carbon atom, nitrogen atom, oxygen atom, sulfur atom or selenium atom; the ring containing Z and N and the ring containing Z′ and N, each represent a monocyclic, bicyclic or tricyclic heteroaryl or partially saturated heteroaryl group, which is unsubstituted or substituted by a substitutent selected from a group consisting of hydroxy, alkyl, alkoxy, halogen atom, nitro, sulfo, carboxy, alkoxycarbonyl and cyano;
Y represents O or S;
R⁶ represents:
(1) a C₁₋₁₈ alkylene group, unsubstituted or substituted with a halogen atom, a C₁₋₁₈alkoxy or oxo group,
(2) an ether group consisting of a C₁₋₁₈ alkylene group interrupted by one or more oxygen atoms, and
(3) -p-C₁₋₆ alkyl-benzyl-;
R⁷ represents a hydrogen atom, a halogen atom, C₁₋₁₈ alkyl, C₁₋₁₈ alkoxyl, carboxyl, C₁₋₁₈ alkoxycarbonyl, C₁₋₁₈ alkylaminoalkylenecarboxyl, adamantyl, amino, mono- or di-(C₁₋₁₈ alkyl)amino, amido, sulfo, sulfonyl, boronic acid, nitro, trifluoromethyl, fluorosulfonyl (—SO₂F), hydroxyl, ferrocenyl, cyano, nitrogen- or oxygen-containing heterocyclic group;
(b) an anion of formula (B): 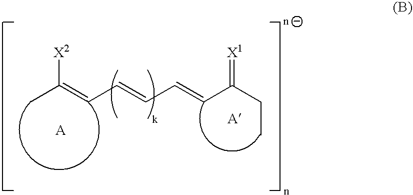
wherein
X¹ and X² each represent an oxygen atom;
ring A and ring A′ each represent an unsubstituted or substituted organic cyclic structure;
k is an integer selected from 0 to 3; and
n is an integer selected from 0 to 2 such that the polymethine complex, as a whole, has neutral electric charge.

4. The polymethine complex of claim 3, wherein the anion has a structure of formula (B-1): 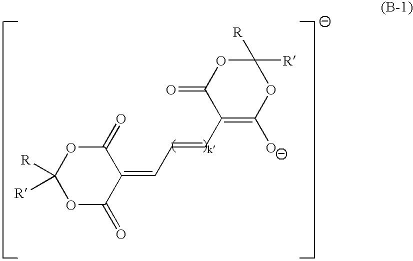
wherein
R and R′ independently represent C₁₋₁₈ alkyl, aryl, mono- or poly-carbocycloc group or ferrocenyl; and
k′ represents an integer of 1 or 2.

5. An optical recording medium comprising at least:
a first substrate;
a recording layer provided on the first substrate, comprising at least one polymethine complex according to claim 1 as the optical recording material;
a reflective layer provided on the recording layer; and
a second substrate laminated on the reflective layer.

6. The optical recording medium of claim 5, wherein the reflective layer has a thickness of 5 to 300 nm.

7. The optical recording medium of claim 5, wherein the recording layer has a thickness of 30 to 200 nm.

8. The optical recording medium of claim 5, wherein the recording layer is provided on the first substrate by a method selected from spin coating, roll coating, dip coating and ink jet printing.

9. The optical recording medium of claim 5, wherein the second substrate is laminated on the reflective layer by a method selected from spin coating, screen printing and hot melt glue coating.
